(19) United States
(12) Patent Application Publication
(10) Pub. No.: US 2002/0019783 A1
(43) Pub. Date: Feb. 14, 2002

(54) Goods delivery system and operating method thereof

(75) Inventor: Yong Seon ChoI, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 09/925,407

(22) Filed: Aug. 10, 2001

(30) Foreign Application Priority Data
Aug. 12, 2000 (KR) 2000-46768
May 10, 2001 (KR) 2001-25489

(51) Int. Cl. G06F 17/60

(52) U.S. Cl. 705/26

(57) ABSTRACT

A goods delivery system and an operating method thereof, which can conveniently perform receipt or return of goods purchased in an online shopping mall through a network such as an Internet, are disclosed. The present invention performs delivery of the goods or temporary custody of the returned goods in a completely unmanned state, and allows only a right recipient to receive the goods.

### BACKGROUND OF THE INVENTION

1. Field of the Invention

The present invention relates to a goods delivery system and an operating method thereof, and more particularly, to a goods delivery system and an operating method thereof, which can allow a customer to conveniently perform receipt of goods purchased in an online shopping mall through a network such as an Internet or return of the purchased goods, perform temporary custody of the delivered or returned goods in a completely unmanned state, and allow only a right recipient to receive the corresponding goods.

2. Background of the Related Art

Presently, a rapid progress in an information & communication field related with a computer not only epochally increases operation efficiency but also largely changes a human's life-style. For example, in shopping related with goods purchase, the goods purchase using online shopping malls on a computer is gradually increased.

A common progressive process of such electronic commerce will be described hereinafter in brief.

First, if a customer visits an online shopping mall after connecting to an Internet using a terminal connectable to the Internet (for example, a PC, a mobile communication terminal, a web TV and a mobile PC), the online shopping mall displays possessed various goods on a screen of the customer's terminal.

In this state, the customer purchases desired goods while confirming details such as functions of goods, cost, the conditions of sale, and so on through search of the goods displayed on the screen.

If the customer requests a purchase of the desired goods through the above steps, a common goods ordering process is performed and the order of the desired goods is finished through confirmation of a settlement method using such goods ordering process. At this time, as the settlement method, there are settlement by non-bankbook deposit, settlement using a credit card and settlement using electronic money.

After that, the online shopping mall transfers the purchased goods to the corresponding customer based on the settled statement.

However, the conventional online shopping mall has a disadvantage that it takes much time to deliver the goods if the corresponding recipient is not in when the purchased goods is delivered.

Especially, if the purchased goods are things going bad quickly, such as foodstuffs, a fast transfer must be performed. However, as described above, if the customer is not in, as the goods such as the foodstuffs may go bad, most of the online shopping malls do not sell such foodstuffs.

Thus, customers who want to purchase the specific foodstuffs must directly go to a store selling the corresponding foods.

Moreover, in the conventional online shopping malls, even though the customer wants to return the purchased goods because the customer is not satisfied with the delivered goods or the delivered goods is defective, the return of the delivered goods is very difficult.

### SUMMARY OF THE INVENTION

Accordingly, the present invention is directed to a goods delivery system and an operating method thereof that substantially obviate one or more problems due to limitations and disadvantages of the related art.

An object of the present invention is to provide a goods delivery system and an operating method thereof, which can allow a customer to directly select a kiosk (kiosk) constructed on a place where the customer wants to receive goods, to easily receive the goods by delivering the purchased goods to the selected place, to settle accounts of the purchased goods when the customer receives the goods, and to conveniently return the purchased goods through the kiosk, and operate the kiosk to perform its own services in a completely unmanned state.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a goods delivery system includes: a server network having an acceptance part for receiving a request of purchase or return of various goods from a customer on online, a settlement part for performing the settlement of the purchased goods on online, and a data sending/receiving part for sending or receiving a statement of goods delivery or goods return; a plurality of kiosk, each kiosk having a data sending/receiving part connected to the server network for receiving information of the statement of the goods delivery generated from the server network and for sending information of the statement of the goods return, and a plurality of goods custody parts for temporarily keeping the delivered or returned goods, a receipt authority confirming part for confirming whether or not a goods recipient has the authority to receive the goods, and a controlling part for generally controlling the components of the kiosk; and an database linked with the server network, the database storing information of a statement received through the acceptance part, information of a statement of goods settlement, information of the current condition of the kiosks, information of each customer, information of goods delivery and information goods return.

In another aspect of the present invention, a method for operating a goods delivery system includes the steps of: making a server network demand a customer to input various information required for goods selling and goods delivery when the customer requests purchase of various goods through an acceptance part of the server network; forming database the input information when the information is input, storing data into an database and transferring a statement of goods delivery of the corresponding goods to a kiosk installed at a place designated by the customer; continuously confirming whether or not the goods to be put in the kiosk are delivered based on the statement of goods delivery receiving from the server network; notifying information of delivery confirmation from the kiosk to the server network when the goods are delivered; and notifying the delivery of the corresponding goods to a goods recipient by the kiosk or the server network.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a brief view of a structure of a goods delivery system according to the present invention;

FIG. 2 illustrates a flow chart of a general operation process of a server network for operating the goods delivery system according to the present invention;

FIGS. 3a and 3b illustrate flow charts of embodiments of a process for confirming a kiosk on a designated goods receiving place of the goods delivery system according to the present invention;

FIGS. 4a, 4b and 4c illustrate flow charts of embodiments of a process for generating secrete number, which must be input when a customer receives the goods;

FIG. 5 illustrates a flow chart of an operation process of the server network, which is operated to order the goods to be delivered from each store;

FIG. 6 illustrates a flow chart of an operation process of the kiosk operated for confirming whether or not the goods to be delivered is received;

FIG. 7 illustrates a flow chart of an operation process of the kiosk operated for maintaining the inside of a goods custody part in different temperature according to kinds of the goods taken into the goods custody part;

FIG. 8 illustrates a flow chart of an operation process of the kiosk performed for receiving the taken goods;

FIG. 9 illustrates a flow chart of an operation process of the kiosk when the customer requests return of the delivered goods through the kiosk; and

FIG. 10 illustrates a flow chart of an operation process of the server network when the customer requests return of the delivered goods through the server network.

### DETAILED DESCRIPTION OF THE INVENTION

Reference will now be made in detail to the preferred embodiments of the present invention, examples of which are illustrated in the accompanying drawings.

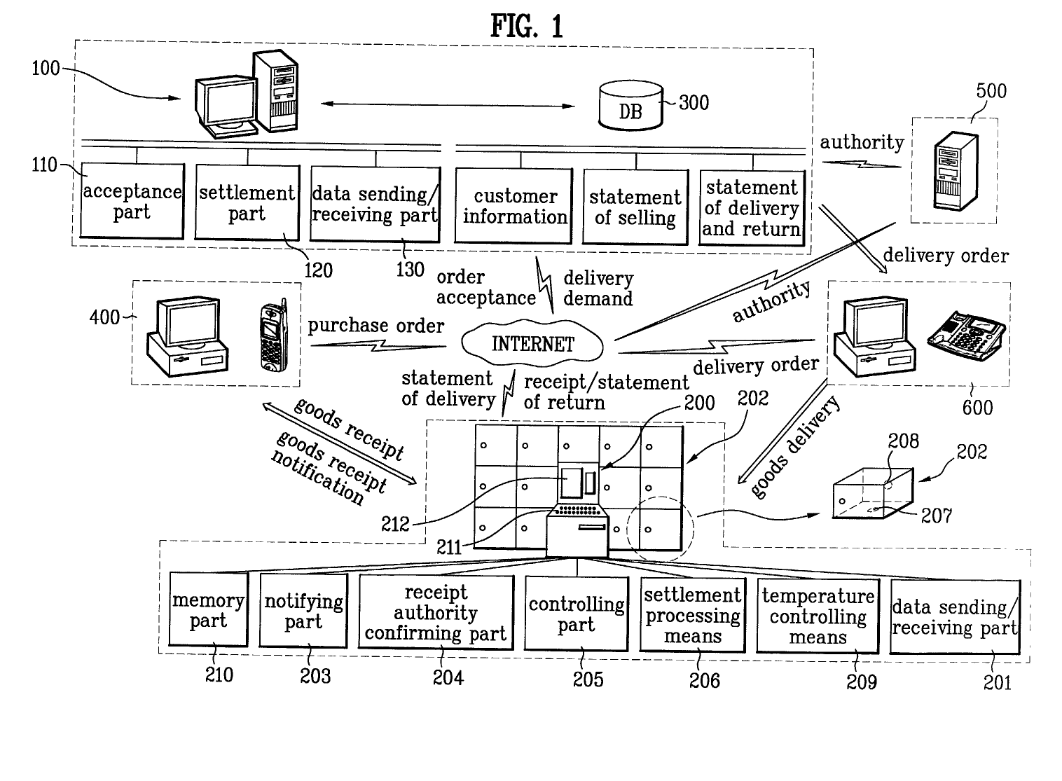

First, FIG. 1 illustrates a brief view of a structure of a goods delivery system according to the present invention.

That is, the goods delivery system includes a server network 100 for selling various goods on online and for receiving various orders of purchase/return of the goods, a kiosk (goods custody device) 200 for delivering the goods sold through the server network 10 or delivering the goods returned to a shopping mall, which the server network operates, and an database 300 for storing order statements of the goods, customer information and so on.

At this time, the server network 100 includes an acceptance part 110 for taking order of purchase of various goods from customers on the online, a settlement part 120 for performing the settlement of accounts of the sold goods on online, and a data sending/receiving part 130 for sending or receiving statements of delivery or return of the goods.

Moreover, the kiosk 200 includes a data sending/receiving part 201, at least one or more goods custody part 202, a notifying part 203, a receipt authority confirming part 204 and a controlling part 205.

The data sending/receiving part 201 is connected with the server network 100 on online, receives information of the goods delivery statement generated from the server network 100 and sends information of goods return statement to the server network 100.

The goods custody part 202 is constructed for temporarily keeping the delivered or returned goods in custody.

At this time, the goods custody part 202 is a cabinet for keeping goods in custody and is locked by the controlling part 205. The data sending/receiving part 201 is a network connecting part for connecting common networks in online, and for the data sending/receiving part, there is an INC (Network Interface Card) or a wireless local area Network.

The notifying part 203 notifies information of the goods custody to a terminal 400 of a customer, who is an object of goods delivery, or the server network 100 if the goods custody into the goods custody part 202 is confirmed.

The receipt authority confirming part 204 confirms whether or not a right recipient who receives the goods has the authority for receiving the goods.

The controlling part 205 generally controls the above components.

Furthermore, the kiosk 200 further includes settlement processing means 206 connected to networks 500 of various financial institutions or bank agencies for allowing the customers to directly settle accounts of the kept goods.

The kiosk 200 further includes a sensing part 207 for confirming whether or not the corresponding goods are kept in the goods custody part 202 in custody.

At this time, the sensing part 207 may be an object sensing sensor for sensing existence of an object or a weight sensing sensor for confirming whether or not the goods is carried in or out by measuring a change of weight of the goods custody part.

The kiosk 200 further includes a temperature measuring sensor 208 for continuously sensing the inside temperature of the goods custody part 200, and temperature controlling means 209 operated to change the custody temperature of the inside of the goods custody part 202 according to the inside temperature of the goods custody part 200, which measured by the temperature measuring sensor, and kind of the goods kept in the goods custody part 202 in custody.

At this time, the temperature controlling means 209 includes a compressor, a condenser, a heat exchanger, an evaporator, etc. of a common cooling system and is constructed to be operated in a cooling cycle, but its description will be omitted.

Such temperature controlling means 209 may be provided to the whole goods custody parts 202, or separate temperature controlling means may be connected to each goods custody part 202 through cooling air transferring means such as a duct or connected to only specific goods custody parts 202, but such construction of the temperature controlling means 209 is not restricted to them.

The kiosk 200 further includes a memory part 210 for temporarily storing information of goods custody statement.

The information stored in the memory part 210 is temporarily stored for a prescribed period of time, and if the prescribed period of time is passed, the temporarily stored information is deleted to minimize a storing space required for information storage.

At this time, the prescribed period of time means a period from the time that the customer has received the corresponding goods to an available return time set by a seller (the online shopping mall).

That is, if there is a request for return of the delivered goods through the kiosk 200 within the set return period of time, the return of the goods can be performed smooth.

The kiosk 200 includes an input part 211 for inquiring or searching various information or inputting information and a display part 212 for outputting the corresponding information of the input contents.

That is, the kiosk 200 according to the present invention serves as a common unmanned kiosk, allows the customer to exactly confirm a progressive state of the goods delivery and safely keeps the delivered goods in custody. Additionally, the kiosk 200 may be installed in various places, for example, in public areas such as subway stations and parks or in stores operated for 24 hours, oil stations or 365 centers in banks. Thus, the customers can conveniently use the kiosk 200.

The database 300 for storing various information is directly connected with the server network 100 and stores various information received through the acceptance part 110 of the server network 100 by classification, such as an order statement, a goods settlement statement, current state information of each goods custody means, information of the customer and the goods recipient, information of goods delivery and goods return and so on.

Meanwhile, the goods purchased and ordered by the customer through the online shopping mall may be directly delivered by a company operating the online shopping mall, delivered to a designated place through a delivery company linked with the company operating the shopping mall, or delivered by a store, which is located in the nearest place from the kiosk 200 designated by the customer, of offline stores linked with the company operating the shopping mall. The present invention will be described that the purchased goods are delivered through communication means 600 provided in the online shopping mall and in the offline stores.

Such goods delivery can be enlarged to items of goods requiring a short delivery time, such as foodstuffs, for example, bean curd, bean sprouts, spinaches, milk, bread, etc. The goods delivery process according to the present invention can reduce costs required for the goods delivery since the corresponding offline store directly performs the goods delivery.

The goods delivery system as described above can deliver the desired goods within a desired time to a desired place by linking the kiosk 200, which is an intermediate delivery place, with the electronic commerce system, thereby maximizing the customer's a sense of satisfaction. Additionally, since the goods delivery system is linked with various offline stores, the whole regional commerce is possible, thereby achieving activation of the commerce.

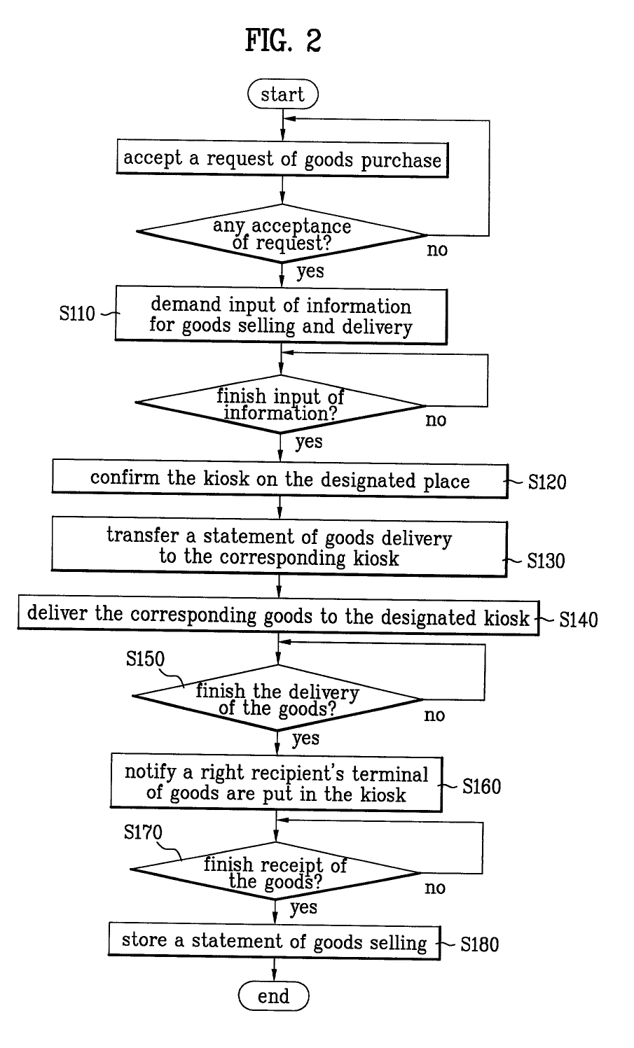

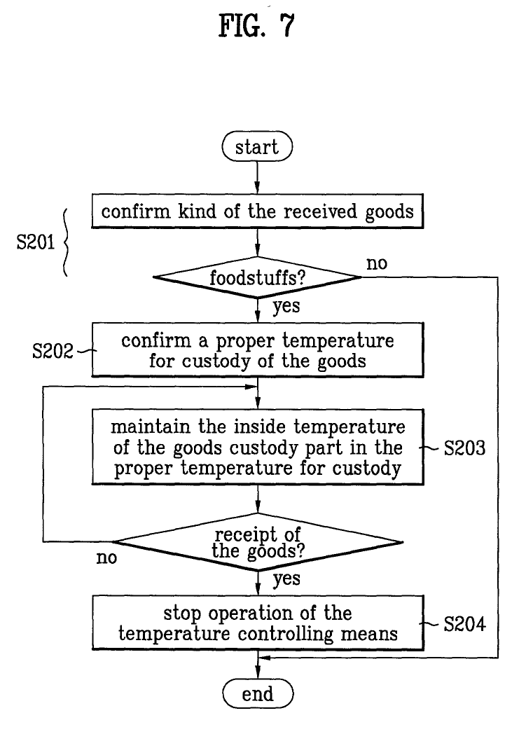

Referring to flow charts of FIGS. 2 through 10, service progressive processes through an operation method of the goods delivery system according to the present invention will be described in more detail.

First, if the customer who connects to the shopping mall operated by the server network 100 through an Internet determines purchase of specific goods while searching information of various goods and requests the purchase of the corresponding goods, the server network 100 operating the shopping mall takes order of the purchase of the goods requested by the customer through the acceptance part 110 (S110).

Such step is carried out by displaying an input screen of information required for selling and delivering the corresponding goods on the customer's terminal 400 and demanding the customer to input various information.

At this time, the various information required for selling and delivering the corresponding goods may be personal particulars of purchasing customer, personal particulars of goods recipient, information of communication terminal, a place for receiving the goods, settlement information, delivery completion time, etc.

The personal particulars of the customer or the goods recipient may be an identification number such as ID or a resident registration number for confirming the corresponding customer and are matters for making the kiosk easily confirm the goods keeping place (specific goods custody part) of the corresponding goods.

If the goods recipient's mobile communication terminal 400 is a terminal having a customer discrimination function through a proximity connection or a settlement function, the customer may input the terminal's phone number into the personal particulars of customer. Therefore, when the customer receives the goods, the confirmation of the goods recipient can be easily performed by the proximity connection to the corresponding mobile communication terminal.

The communication terminal information is information of the terminal 400, which allows the customer or the goods recipient to receive notification of the current progressive state of the purchased goods. If the terminal is a PC, the terminal information may be an address of messenger service or an E-mail address, and if the terminal is the mobile communication terminal, the terminal information is the phone number of the corresponding mobile communication terminal.

The requested goods receiving place means a place that the customer wants to receive the corresponding goods and may be a place where the kiosk is installed.

The settlement information may be input a request of whether to settle accounts of the goods purchased through the online shopping mall by online depositing, to settle the accounts by a credit card, to settle using electronic money, or to settle in the kiosk when the goods are received.

At this time, the settlement method in the kiosk can solve a sense of unease of security caused when the customer settles on online, by allowing the customer to directly perform offline settlement such as cash payment, settlement through account transfer or settlement using the credit card since the kiosk has the common kiosk function.

The delivery completion time means a limit time till the customer or the recipient receives the goods, which is designated by the customer, and it is preferable to allow additional time for delays.

The information input may be set to allow the customer to input in letters or performed through a selective information input method such as a GUI (Graphic User Interface).

If the required information input by the customer is obtained, the server network 100 communicates with the kiosk 200 of the designated place, confirms various information of the corresponding kiosk 200 (S120), and provides the delivery statement of the corresponding goods to the kiosk 200 (S130).

At this time, in the step for confirming information of the kiosk 200, if the kiosk does not have extra goods custody parts, it is preferable to notify it to the customer and guide to select the kiosk constructed in another place.

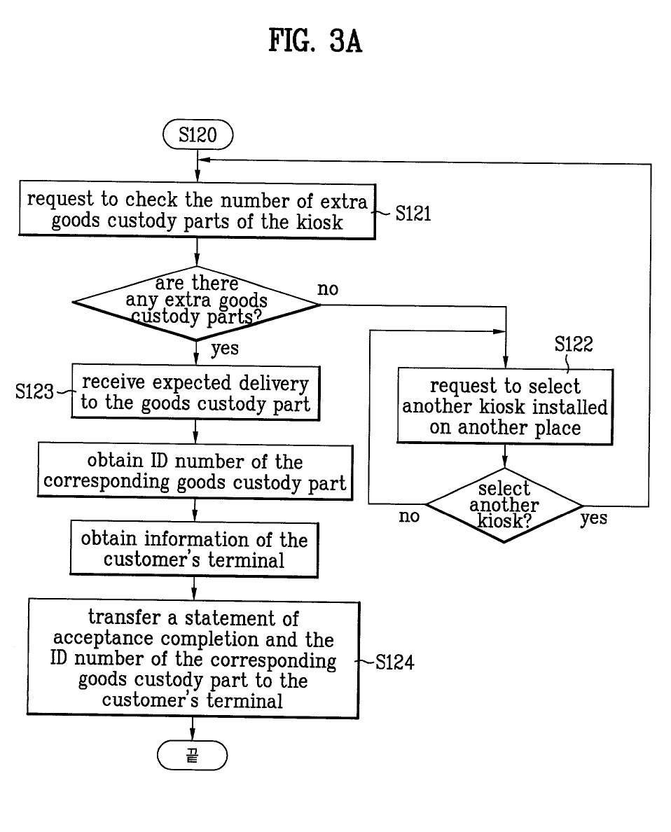

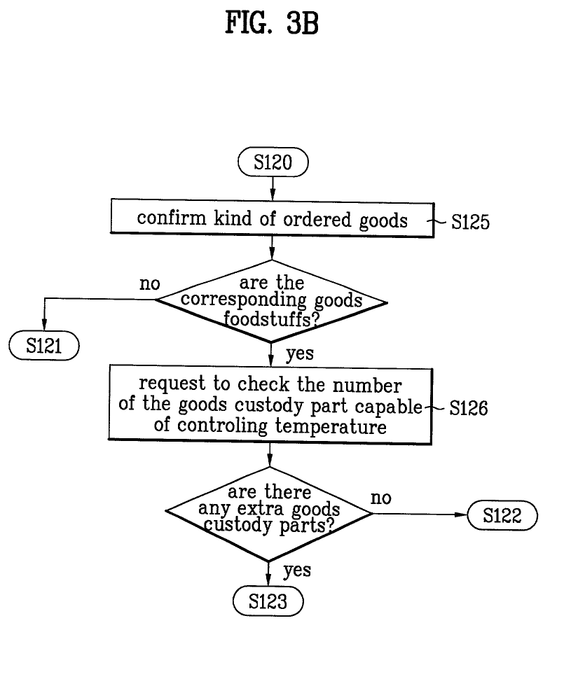

As shown in FIG. 3a, the server network confirms extra goods custody parts of the kiosk and permits the storage of the goods or notifies a state, that the customer cannot keep the goods in the designated kiosk, according to the confirmed state.

That is, if the server network 100 demands a check of extra goods custody parts to the kiosk, the kiosk 200 checks the current number of the extra goods custody parts 202 or the number of the goods custody parts capable of keeping the goods for the expected time of delivery, and notifies the checked matters to the data sending/receiving part 201 of the server network 10.

In this step, if there is no extra goods custody part of the kiosk installed in the designated place, the server network notifies it to the customer and guides to select the kiosk constructed in another place (S122). If not so (if there is the extra goods custody parts), the server network sends the delivery statement of the goods to the kiosk having the corresponding goods custody part (S123), and then notifies the customer of information of the purchase acceptance completion and an ID number of the corresponding goods custody part (S124).

However, the process is not restricted in the above. If the server network 100 accepts the purchase of the goods while continuously checking the current state of the kiosk 200, that is, the number of the extra goods custody parts 202 and the ID number of the corresponding goods custody part 202, forming a database of the checked contents and storing in the database 300, the server network 100 can be constructed to promptly check and notify whether or not the goods can be delivered, in response to the customer's specific place selection.

Furthermore, if the purchased goods are foodstuffs, especially, going bad quickly within a short time, the goods must be safely and stably kept in custody.

Since several goods custody parts of the kiosk 200 have the temperature controlling function, the server network 100 determines whether or not the goods can be delivered, in consideration of the kinds of the ordered goods.

That is, as shown in FIG. 3b, during the step for confirming the extra goods custody parts 202 of the kiosk 200 installed in the designated place, if confirming that the purchased goods are foodstuffs going bad quickly within a short time, the server network 100 checks the number of the extra goods custody parts 202 (S126) and determines whether or not the corresponding goods can be delivered.

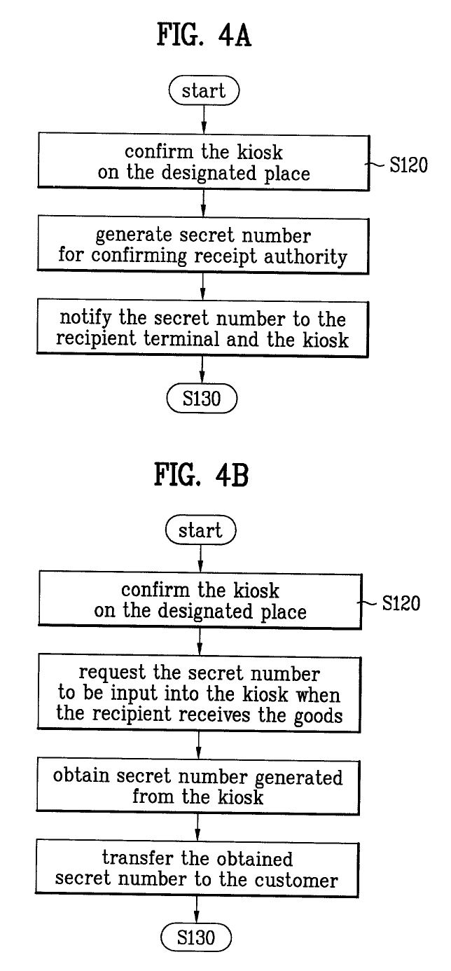

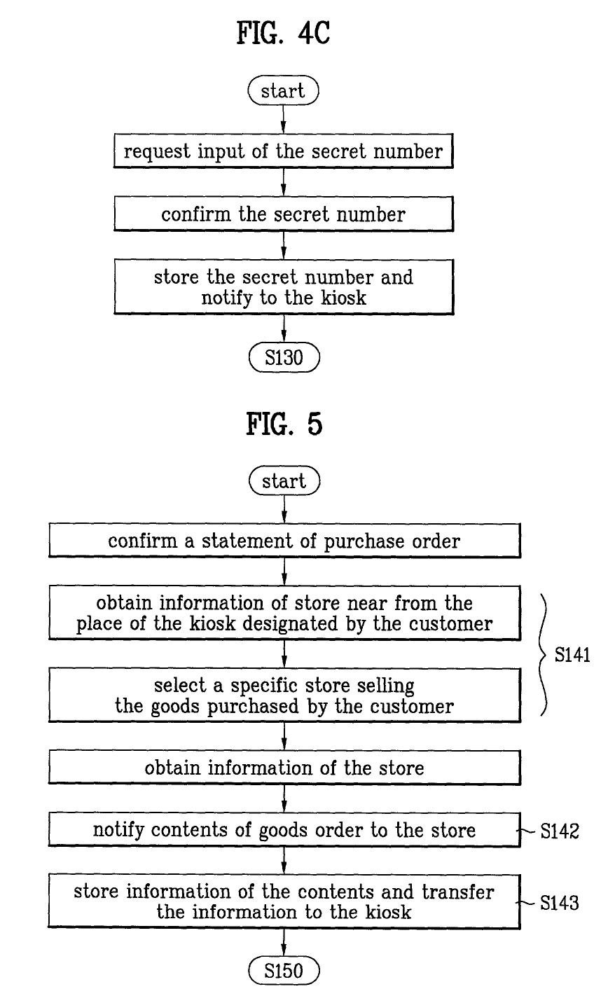

Meanwhile, when the selection of the kiosk 200 is finished, as shown in FIG. 4a, the server network 100 generates a secret number at random for inputting to the receipt authority confirming part 204 of the kiosk 200 when the goods are received, notifies the generated secret number to the corresponding customer (or the goods recipient)'s terminal and the corresponding kiosk 200, and sends the kiosk 200 delivery information of the corresponding goods, so that the corresponding goods custody part 202 does not keep other goods for the prescribed period of time.

At this time, the customer's terminal may be the mobile communication terminal, and to notify information to the mobile communication terminal, it is preferable to use an SMS (Short Message Service).

However, the server network is not restricted in the generation of the secret number. As shown in FIG. 4b, if the kiosk receives the delivery statement of the specific goods from the server network, the server network may set the goods custody part corresponding to the delivery statement, demand the secret number to be input into the receipt authority confirming part for allowing the customer or the recipient to receive the corresponding goods from the goods custody part, receive the secret number generated by the corresponding kiosk, store the secret number into the database and notify the secret number to the corresponding terminal.

Of course, the kiosk generating the secret number may directly notify the corresponding customer of the secret number.

Moreover, the secret number is not restricted in the random generation of the server network or the database. As shown in FIG. 4c, the server network 100 may allow the customer to directly select the secret number and set as the secret number for confirming the goods receipt authority.

Meanwhile, if the selection of the kiosk 200 through the above process is finished, the server network 100 performs the operation for delivering the required goods to the corresponding kiosk 200 within the designated period of time (S140).

Referring to FIG. 5, the delivery process will be described in more detail.

First, the server network 100 confirms the statement of the goods purchase required by the customer and selects a delivery store for delivering the purchased goods.

The delivery step is performed by obtaining information of the purchased goods from the input information and selecting the store located at the nearest place from the kiosk 200 selected by the customer (S141).

If the selection of the store is finished, the server network 100 operating the online shopping mall sends contents of the goods order to the selected store using the agreed information transferring method (S142).

At this time, as the information transferring method, there are transferring methods through a common phone call and through an Internet communication (for example, messenger service, e-mail service, etc.).

After that, the server network 100 forms database of the various information (such as statement of the goods delivered, information of the goods recipient, information of the stored, which delivers the goods, etc.), stores in the database 300, and transfers the information data to the data sending/receiving part 201 of the kiosk 200 through the data sending/receiving part 130 (S143).

However, it is not necessary that the transferring process must be performed after completion of the receipt of the goods purchase.

That is, the server network 100 may confirm the available store and the available time for delivering the goods during receiving the goods purchase from the customer, select the store most suitable to the customer's request (request of delivering to the specific place within the specific period of time), finish the receipt of the goods purchase, and then transfer the statement to the data sending/receiving part.

Meanwhile, if the above process is finished, the server network communicates with the corresponding kiosk and continuously confirms whether or not the delivery of the goods is finished (S150).

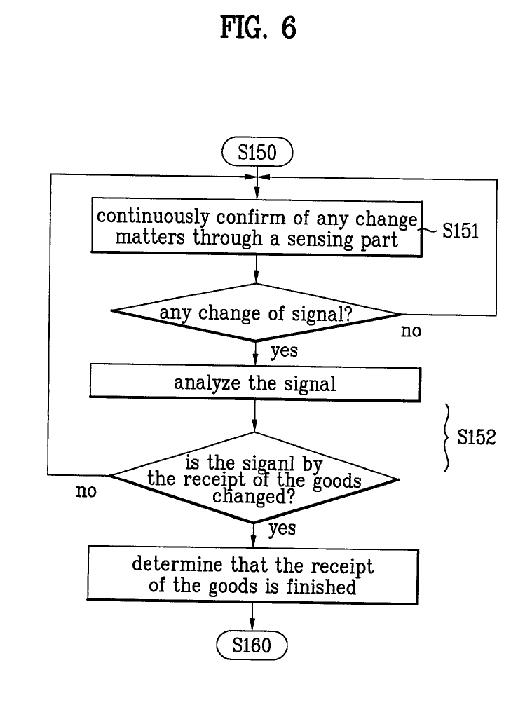

Referring to FIG. 6, an operation process of the kiosk will be described in more detail as follows.

First, the kiosk 200 continuously confirms whether or not the goods corresponding to the goods delivery statement received from the server network 100 are kept in custody (S151).

At this time, as the method for confirming whether or not the goods are kept in custody, there are a method that a delivery man puts the goods into the corresponding goods custody part 202 of the kiosk 200 and inputs the fact of the goods keeping through the input part 211 of the kiosk 200, and a method that the sensing part 207 provided in the corresponding goods custody part 202 continuously senses the goods keeping and notifies it to the controlling part 205 of the kiosk 200.

The sensing part 207 continuously senses change matters inside the goods custody part 202 and transfers the sensed signal to the controlling part 205 (S151). The controlling part 205 analyzes the signal transferred from the sensing part 207 and determines whether or not the goods is kept in the goods custody part 202 according to the change of signal (S152).

In this process, if the controlling part 205 of the kiosk 200 confirms that the goods are kept in the corresponding goods custody part 202, the controlling part 205 notifies the server network 100 of delivery completion information.

After that, the server network 100 notifies a message, that the delivery of the corresponding goods is finished, to the customer's terminal 400 (S160).

However, the notification of the goods keeping may be performed not through the server network but other means.

For example, the controller 205 confirming the goods keeping through the sensing part 207 of the kiosk 200 may obtain information of the goods recipient from the server network 100 and directly notify to the recipient' terminal 400.

During the above process, the controlling part 205 confirms the kind of the goods kept in the goods custody part 202 and determines whether the goods is foodstuffs, which must be kept in a low temperature, or articles, which can be kept in the room temperature (S201).

The kind of the goods can be confirmed by confirming the goods name through the goods ordering statement received from the server network 100 or by allowing the delivery man to input the kind of the goods when the customer receives the goods.

If the kept goods are confirmed as foodstuffs, the controlling part 205 confirms a range of the proper custody temperature of the foodstuffs (S202) and maintains the inside temperature of the corresponding goods custody part 202 as the proper temperature for the goods keeping by operating the temperature controlling means 209 to keep the goods within the range of the proper custody temperature (S203).

If the goods are articles, which can be kept in the room temperature, there is no need to operate the temperature controlling means 209. If the receipt of the corresponding goods is finished, the operation of the temperature controlling means 209 is stopped and the goods custody part is returned into a usual goods keeping state (S204).

Meanwhile, during the above process, the server network 100 communicates with the corresponding kiosk 200 and continuously confirms whether or not the customer or the recipient receives the kept goods (S170).

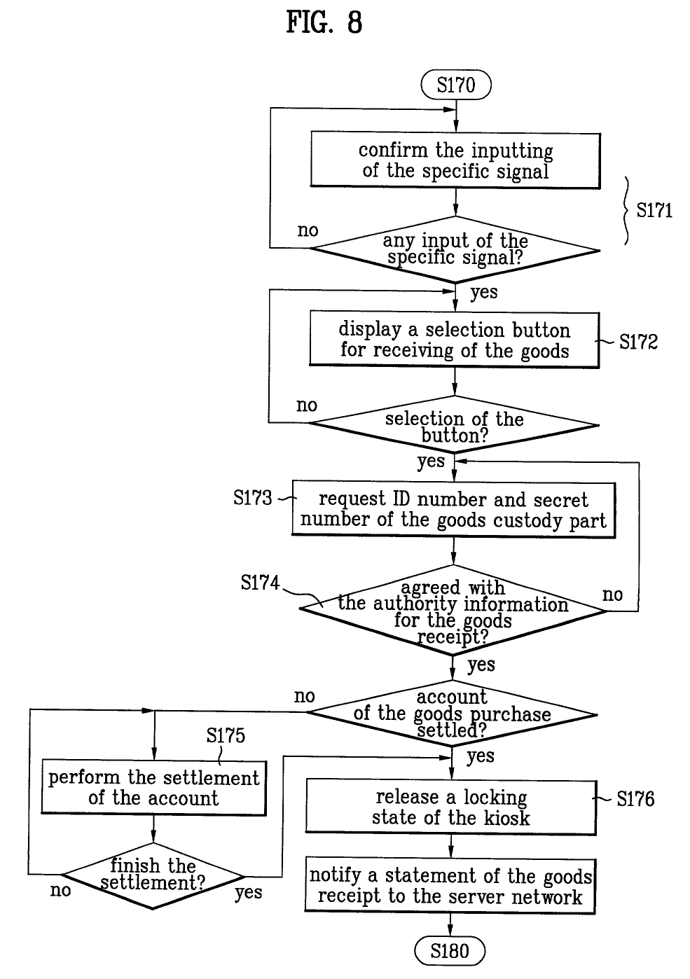

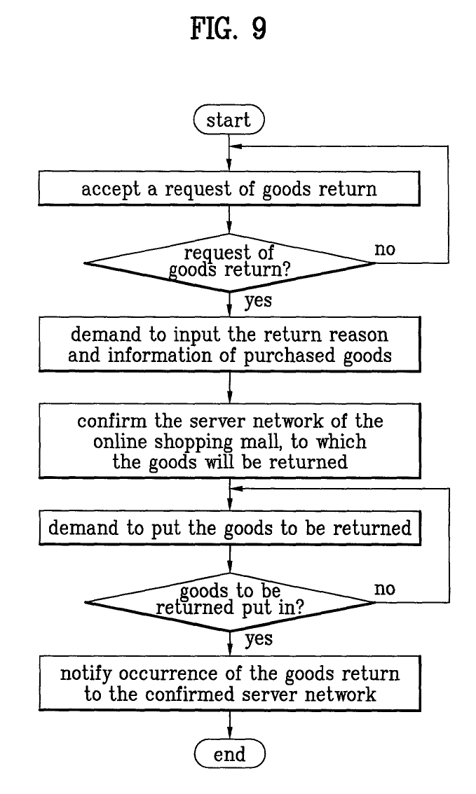

At this time, to confirm whether or not the customer or the recipient receives the kept goods, referring to FIG. 8, an operation process of the kiosk 200 will be described in detail as follows.

First, the kiosk 200, which can keep the goods in custody, continuously confirms whether or not there is any request of the receipt of the goods from the corresponding customer (S171).

The kiosk 200 continuously confirms whether or not the customer inputs signal the input part 211 thereof.

That is, in a stand-by state, if the specific signal is input through the input part 211, the kiosk 200 activates a selection button for goods custody request or a selection button for goods receipt request on the screen of the display part 212 and allows the customer to request the receipt of the corresponding goods (S172).

Of course, preferably, the display part 212 usually displays advertisement, and the selection button is activated only when there is an external operation (if the specific button of the input part is selected), thereby effectively using the kiosk.

In the above state, when the customer clicks the selection button for goods receipt request, the controlling part 205 for controlling the kiosk demands to input the ID number for confirming the customer and the secret number for confirming the ID number and the receipt authority (S173).

At this time, the ID number may be a common ID, a proper number of the goods custody part 202 provided from the server network of the online shopping mall when the customer purchases the goods, a purchase receipt number and a resident registration number. In the present invention, the proper number of the goods custody part 202 is used as the ID number.

If the proper number of the goods custody part 202 and the secret number for confirming the goods receipt authority are input, the receipt authority confirming part of the kiosk 200 confirms whether or not the customer has the authority for receiving the goods through a general authentication step for log-in (S174), obtains information of the customer if it is confirmed that the customer has the authority for receiving the goods, and obtains information of the position of the goods custody part 202, which keeps the goods ordered by the customer, and settlement of the goods.

If the settlement of the goods ordered by the customer is not performed, for example, if the customer selects the purchase settlement method, that the customer settles the accounts of the goods after receiving the goods, during purchasing the goods in the online shopping mall, the controlling part 205 of the kiosk demands the payment of the cost of the goods of the goods recipient (S175).

It is possible as the kiosk 200 is connected to the networks 500 of various financial institutions and has settlement means having kiosk function capable of receiving money.

After that, if confirming the completion of the settlement of the good price, the controlling part of the kiosk releases a locking state of the corresponding goods custody part 202 and allows the customer to receive the goods (S176).

If grasping signal input through the sensing part 207 and confirming the completion of the receipt of the goods, the controlling part 205 forms information of the goods receipt statement as data, stores in the memory part 210 and transfers to the server network 100. The server network stores the transferred information of goods delivery completion statement in the memory part 300 for storing information of the goods selling statement (S180).

At this time, the kiosk 200 can issue a receipt of the purchased goods according to the request of the customer.

Meanwhile, during the above process, if the customer does not take the goods, there is a problem that the kiosk must keep the goods for a long time.

Therefore, the present invention sets a prescribed receipt period of time of the goods based on the limit time input by the customer when the customer purchases the goods. If the customer does not take the goods during the receipt period of time, the kiosk notifies it to the server network 100 to perform return of the goods.

The customer receiving the goods through the above process confirms whether or not the goods are the desired and purchased goods. In this process, if the goods are not the desired and purchased goods, does not satisfy the customer or is bad, the customer requests the return of the goods.

The request of the return of the goods may be performed in the same process as return processes of the general online shopping malls. However, in the present invention, the request of the return is performed through the kiosk 200. For the request of the return of the goods, referring to FIG. 9, an operation process of the kiosk will be described as follows.

First, if determining the return of the received goods, the customer requests the return of the goods according to a prescribed form through the kiosk 200, from which the customer has received the goods, and puts the goods into the goods custody part 202.

At this time, the form for the return request through the kiosk 200 means a form requiring a return reason and at least one information of the purchase receipt number and the secret number provided from the server network 100, the personal particulars of the customer, goods receiving date, or goods name. The kiosk performs a request of delivery to the shopping mall for the return on the basis of the input information.

The controlling part 205 receiving the request of the return compares information, which is input when the customer did request the return of the goods, with the goods delivery statement stored in the memory part 210, and confirms information of the online shopping mall, which have sold the goods.

The method that the kiosk confirms the server network 100, which have sold the goods, based on the information input by the customer is performed by comparing and searching various information temporarily stored in the memory part and information input by the customer.

At this time, the memory part 210 temporarily stores information of the goods delivery statement received from the server network 100 during the delivery process and information of the recipient input when the recipient receives the goods for the prescribed return period of time.

After that, the memory part 210 notifies information of the goods return statement and information of the position of the corresponding kiosk 200 to the server network 100 of the online shopping mall confirmed through the data sending/receiving part 201 and requests the return of the goods.

However, the returning process is not restricted in the above. If the kiosk 200 is connected with other kiosks 200 installed in other places through network to share information with one another, or the goods selling statement of the corresponding online shopping mall stored in the database 300 can be provided to the kiosk 200 according to the request of the kiosk 200, the customer can perform the return process by using the kiosk 200 installed in any place.

Additionally, the customer can connect to the online shopping mall, in which the customer has purchased the goods, to request the return of the goods.

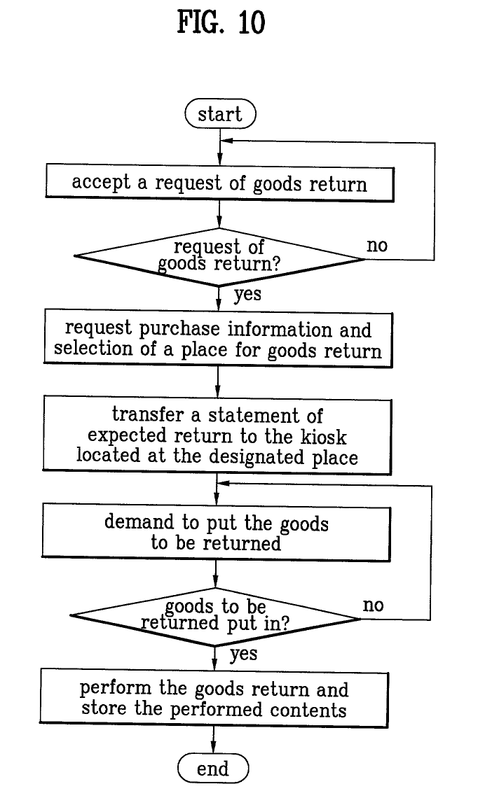

The above process is performed as shown in FIG. 10, and will be described in brief.

First, the customer connects to the server network 100 of the online shopping mall and requests the return of the goods purchased through the acceptance part 110.

The server network 100 receiving the request of the return of the goods demands the customer to select the kiosk 200 of a desired location.

If the customer selects the kiosk 200, the server network 100 transfers the statement of the goods returned to the kiosk 200 installed in the desired location.

At this time, the controlling part of the corresponding kiosk receiving the request of the return of the goods continuously confirms whether or not the goods is put in the goods custody part through the sensing part of the goods custody part. If it is confirmed that the goods are put in the goods custody part, the controlling part transfers information of the returned goods to the server network of the corresponding online shopping mall.

After that, the server network notifies the return of the goods to the delivery company or the store sold the goods to take the returned goods, thereby finishing all processes.

Meanwhile, the goods delivery system using the plurality of kiosks according to the present invention is not restricted in delivering the goods, which the customer has purchased through the online shopping malls. The goods delivery system can be used for the purpose of goods transfer between persons, transfer of the mails requiring the recipient's confirmation such as registered mails or parcels, or personal post-office boxes.

As previously described, the goods delivery system and the operation method thereof according to the present invention can obtain the following effects.

First, when purchasing goods from the online shopping mall through the network, the customer can freely select an intermediate delivery place for receiving the purchased goods.

Therefore, the customer can conveniently receive the goods within the desired time, and thereby the present invention can improve a sense of satisfaction of the customers.

Second, since the customer can settle the accounts of the goods purchased through the online shopping mall when receiving the goods, the present invention provides convenience in the settlement process and can solve a sense of unease of drain of the settlement information.

Third, the customer can conveniently return the purchased goods through the kiosk.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A goods delivery system comprising:
a server network having an acceptance part for receiving a request of purchase or return of goods from a customer on online, a settlement part for performing the settlement of the purchased goods on online, and a data sending/receiving part for sending or receiving a statement of goods delivery or goods return;
a plurality of kiosks, each kiosk having a data sending/receiving part connected to the server network for receiving information of the statement of the goods delivery generated from the server network and for sending information of the statement of the goods return, and a plurality of goods custody parts for temporarily keeping the delivered or returned goods, a receipt authority confirming part for confirming whether or not a goods recipient has the authority to receive the goods, and a controlling part for generally controlling the components of the kiosk; and
a database linked with the server network, the database storing information of a statement received through the acceptance part, information of a statement of goods settlement, information of the current condition of the kiosks, information of each customer, information of goods delivery and information goods return.

2. The system according to claim 1, wherein the kiosk includes settlement processing means connected to various financial institutions in online for allowing the customer to directly settle accounts of the goods.

3. The system according to claim 1, wherein the kiosk further includes a sensing part for confirming whether or not the specific goods are kept in the goods custody part in custody.

4. The system according to claim 3, wherein the sensing part is an object sensing sensor for sensing whether or not the goods is put in the goods custody part or a weight sensing sensor.

5. The system according to claim 1, wherein the kiosk further includes a temperature measuring sensor for continuously sensing the inside temperature of the goods custody part, and temperature controlling means operated for changing the inside temperature of the goods custody part measured by the temperature measuring sensor and the custody temperature of the inside of the goods custody part based on the kind of the goods kept in the goods custody part.

6. The system according to claim 1, the kiosk further includes a notifying part for notifying information of the goods custody to the corresponding customer's terminal or the server network if it is confirmed that the goods are put in the goods custody part.

7. A method for operating a goods delivery system, the method comprising the steps of:
making a server network demand a customer to input various information required for goods selling and goods delivery when the customer requests purchase of various goods through an acceptance part of the server network;
forming database the input information when the information is input, storing data into an database and transferring a statement of goods delivery of the corresponding goods to a kiosk installed at a place designated by the customer;
continuously confirming whether or not the goods to be put in the kiosk are delivered based on the statement of goods delivery receiving from the server network;
notifying information of delivery confirmation from the kiosk to the server network when the goods are delivered; and
notifying the delivery of the corresponding goods to a goods recipient by the kiosk or the server network.

8. The method according to claim 7, further comprising a step of requesting to select one of various confirming methods for determining the recipient's authority for receiving the goods in the goods purchase accepting step of the server network for allowing the right recipient to receive the goods.

9. The method according to claim 8, wherein the method for confirming the recipient's authority for goods receipt is at least one of confirming methods through input an ID, a resident registration number or a secret number, which only the corresponding recipient can recognize.

10. The method according to claim 7, wherein the step of accepting the customer's goods purchase request includes the steps of:
generating a secret number to be input in a receipt authority confirming part of the kiosk when the recipient receives the goods;
obtaining the recipient's terminal information from various purchase information received from the customer; and
transferring the generated secret number to the kiosk and the recipient' terminal.

11. The method according to claim 7, wherein if the kiosk receives a statement of goods delivery from the server network, the kiosk is operated by the steps of:
searching extra goods custody parts capable of keeping the goods in custody and extracting the ID number;
generating a secret number to be input into the receipt authority confirming part for receiving the goods kept in the searched goods custody part; and
transferring the extracted ID number of the goods custody part and the generated secret number to the recipient or the customer's terminal.

12. The method according to 7, wherein if the kiosk receives the statement of goods delivery of from the server network, the kiosk is operated by the steps of:
confirming kind of the corresponding goods;
confirming a range of proper custody temperature of the goods if the goods are foodstuffs; and
operating temperature controlling means for keeping the goods in custody within the range of proper custody temperature.

13. The method according to 7, wherein in the step of continuously confirming whether or not the goods are delivered, a sending part provided in the goods custody part continuously senses a changed state of the inside of the goods custody part, and a controlling part analyzes signal transferred from the sensing part and determines whether or not the goods are delivered into the goods custody part.

14. The method according to 7, wherein if the customer requests return of the goods through the kiosk installed at the place designated by the customer, the kiosk is operated by the steps of:
requesting to input at least one of customer information, goods receiving date and goods name;
confirming the server network, which has sold the corresponding goods, based on the input information; and
transferring information of a statement of goods return and information of the place, where the corresponding kiosk is installed, to the confirmed server network.

15. The method according to claim 7, further comprising the steps of:
requesting the customer to select a place to which the goods are returned if the customer requests the return of the goods through the acceptance part of the server network;
transferring a statement of return of the corresponding goods to the kiosk installed at the place for the return of the goods if the place for the return of the goods is selected;
continuously confirming by the kiosk whether or not the corresponding goods are returned, based on the statement of return received from the server network; and
notifying the fact that the corresponding goods are returned, from the kiosk to the server network if the corresponding goods are returned.

16. The method according to 15, wherein the step of confirming the server network, which has sold the corresponding goods, based on information input by the customer includes the steps of: temporarily storing information of the statement of delivery of the goods transferred from the server network and recipient information input by the recipient during an available return period of time when the recipient receives the goods; comparing the temporarily stored information to various information input by the customer if there is a request of goods return from the customer within the available return period of time; and confirming the server network, which has sold the corresponding goods.

17. The method according to 7, further comprising the steps of:
setting a prescribed goods receiving period of time based on an expected goods receiving time input by the customer at the time of initial goods selling; and
if the goods are kept in the kiosk in custody and the recipient does not take the corresponding goods within the set receiving period of time, notifying it to the corresponding server network by the kiosk to perform the return of the goods.
